(19) United States
(12) Patent Application Publication
(10) Pub. No.: US 2005/0029179 A1
(43) Pub. Date: Feb. 10, 2005

(54) Injection nozzle with fuel filter

(76) Inventor: Albert Hatz, Ruhstorf (DE)

Correspondence Address: KATTEN MUCHIN ZAVIS ROSENMAN, 575 MADISON AVENUE, NEW YORK, NY, 10022-2585, US

(21) Appl. No.: 10/939,913

(22) Filed: Aug. 26, 2004

Related U.S. Application Data
(63) Continuation of application No. PCT/EP03/01013, filed on Feb. 1, 2003.

(30) Foreign Application Priority Data
Feb. 27, 2002 (DE) 102 08 569.2

(51) Int. Cl. B01D 35/00

(52) U.S. Cl. 210/171; 210/416.4

(57) ABSTRACT

In an injection nozzle (1) with fuel filter for reciprocating-piston internal-combustion engines, with a filter body (8) in the pressure line (13) of a nozzle holder (2) comprising holding body (3) and nozzle body (4), the filter body (8) is substantially disk-shaped, the filter body (8) being clamped between holding body (3) and nozzle body (4), and the filter surface or filter slots being formed by one or more fine cuts in the filter body (8).

This application is Continuation Under 35 U.S.C. 111(a) of Intl Application No. PCT/EP03/01013, filed Feb. 1, 2003, which claims the benefit under 35 U.S.C. 119(a-d) of German Application No. 102 08 569.2, filed Feb. 27, 2002.

The invention relates to an injection nozzle with fuel filter for reciprocating-piston internal-combustion engines, with a filter body in the pressure line of a nozzle holder comprising holding body and nozzle body.

In injection nozzles, which are made of high-precision fitting parts, fuel filters are necessary in order to protect the sensitive components from particulate contaminants in the form of metal chips or detached burrs in the fuel. Such fuel filters therefore prolong the useful life of the injection nozzle and ensure trouble-free operation thereof.

Known edge-type filter elements are inserted either in the holding body of the nozzle holder or outside this body, within screwed connecting couplings in the fuel pressure line. By a partition wall separated from the wall of the pressure duct by the width of a slot and extended in duct direction, they permit the collection of undesired residues in a dirt space on one side of the partition wall. The fuel washing around the partition wall in circumferential direction passes via a clean space on the clean side of the edge-type filter into the pressure duct leading to the nozzle body.

The effectiveness of such edge-type filters is limited, since they need so much installation space that they can be mounted only at a distance from the nozzle body, and since the residues progressively fill up the dirt space and in some cases remain caught in the filter slots. As a result, functional impairments occur and can be eliminated only by replacing the edge-type filter or the component housing it. Because of the tight-fitting pressed-in seat, metal particles may be detached in the process of mounting such edge-type filters.

In contrast, the object of the present invention is to provide an injection nozzle of the type mentioned hereinabove, with a fuel filter that is characterized by a particularly small installation volume relative to its filter surface, that is simple to manufacture and to mount and that is superior to the known edge-type filters in terms of its size-reduction effect.

This object is achieved by the invention in that the filter body is substantially disk-shaped,
in that the filter body is clamped between holding body and nozzle body, and
in that the filter surface or filter slots are formed by one or more fine cuts in the filter body.

These fine cuts are preferably made as laser cuts. Production thereof is not expensive, because machining is simplified by the disk shape of the filter body and because it is possible to work with relatively thin disks.

In a preferred embodiment of the filter body, the pressure line opens and/or discharges into prechambers of the filter body, which prechambers communicate with the filter surface or with the filter slots. The residues accumulate in these prechambers, where they are exposed to the effect of the pulsating flow until they are ground to pieces and reduced in size to the point that they are able to pass through the fine slits formed by the filter slots. In the process, the size-reduction effect is promoted by the fact that the high-pressure stream is directed perpendicularly against disk surfaces, which are oriented transversely thereto and into which the fine filter slits are machined. Thus a chip to be reduced in size is swirled around in the prechamber and hurled against these disk surfaces until it passes through the slit or slits. From the viewpoint of manufacturing engineering, it is expedient that the prechambers are formed by grooves, which contain the fine cuts substantially in the region of their groove bottom.

By the fact that the filter body according to a further alternative configuration is composed of a plurality of disks, the possibility is achieved of forming the grooves as openings in the cover disks and machining the fine slits into a separate filter disk, then mounting this between two cover disks in such a way that the slitted filter disk is fitted between cover disks forming prechambers.

By virtue of the disk-shaped configuration of the filter body, the possibility exists that it can be positioned at the location of the usual intermediate plate between holding body and nozzle body. The filter body then takes over the function not only of the intermediate plate but also of the fuel filter. Since the remaining pressure line to the filter body is reduced to a short line length, it is possible to collect practically all residues that impair performance.

Two practical examples of the invention will be explained hereinafter with reference to the drawings, wherein

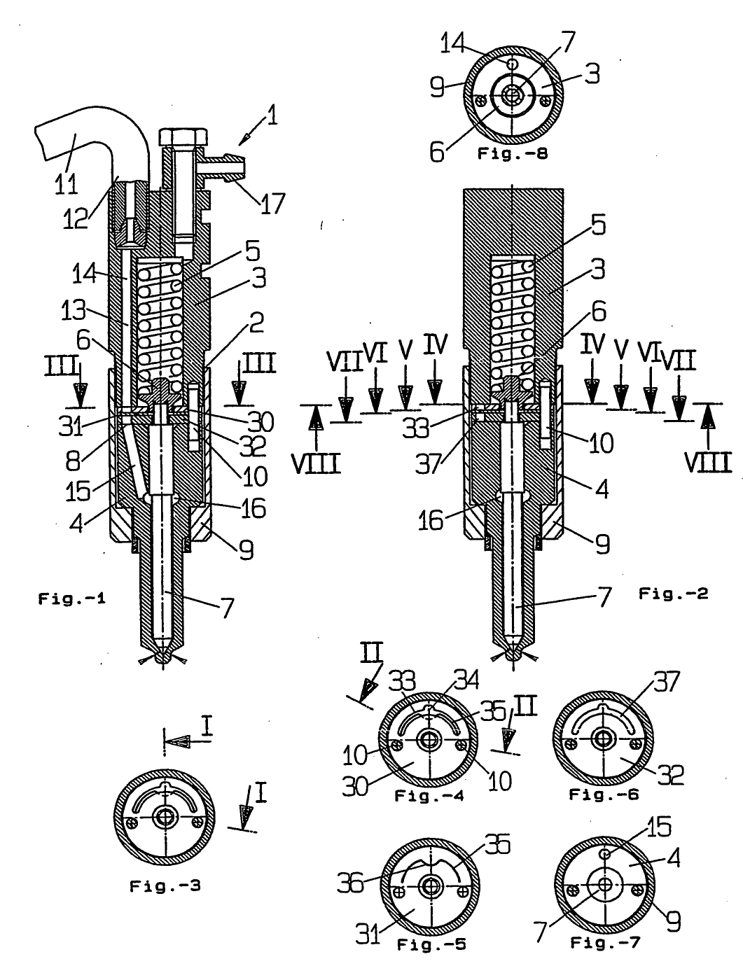

FIG. 1 shows an axial section through an injection nozzle along I-I of FIG. 3

FIG. 2 shows a further axial section along II-II of FIG. 4

FIG. 3 shows a cross section through III-III of FIG. 1

FIG. 4 shows a cross section through IV-IV of FIG. 2

FIG. 5 shows a cross section through V-V of FIG. 2

FIG. 6 shows a cross section through VI-VI of FIG. 2

FIG. 7 shows a cross section through VII-VII of FIG. 2

FIG. 8 shows a cross section through VIII-VIII of FIG. 2

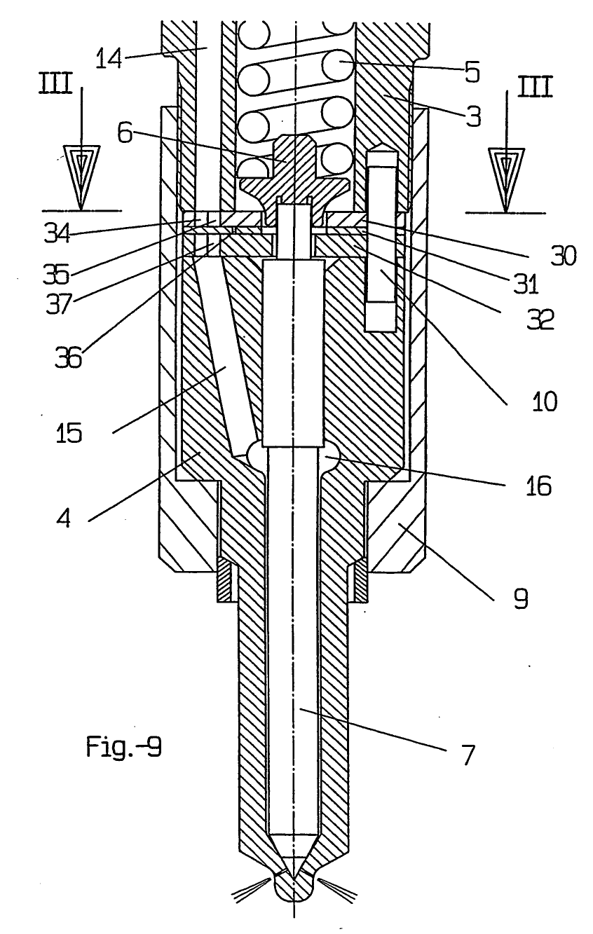

FIG. 9 shows a portion of FIG. 1 on a larger scale

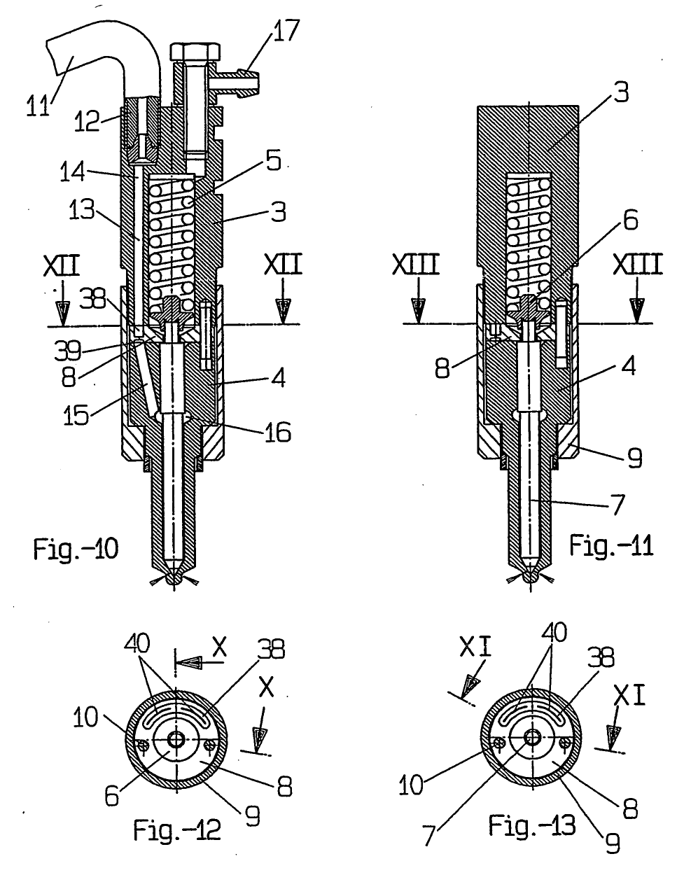

FIG. 10 shows an axial section through a second embodiment of the injection nozzle along X-X of FIG. 12

FIG. 11 shows a further axial section through the second embodiment along XI-XI of FIG. 13

FIG. 12 shows a cross section through XII-XII of FIG. 10

FIG. 13 shows a cross section through XIII-XIII of FIG. 11 and

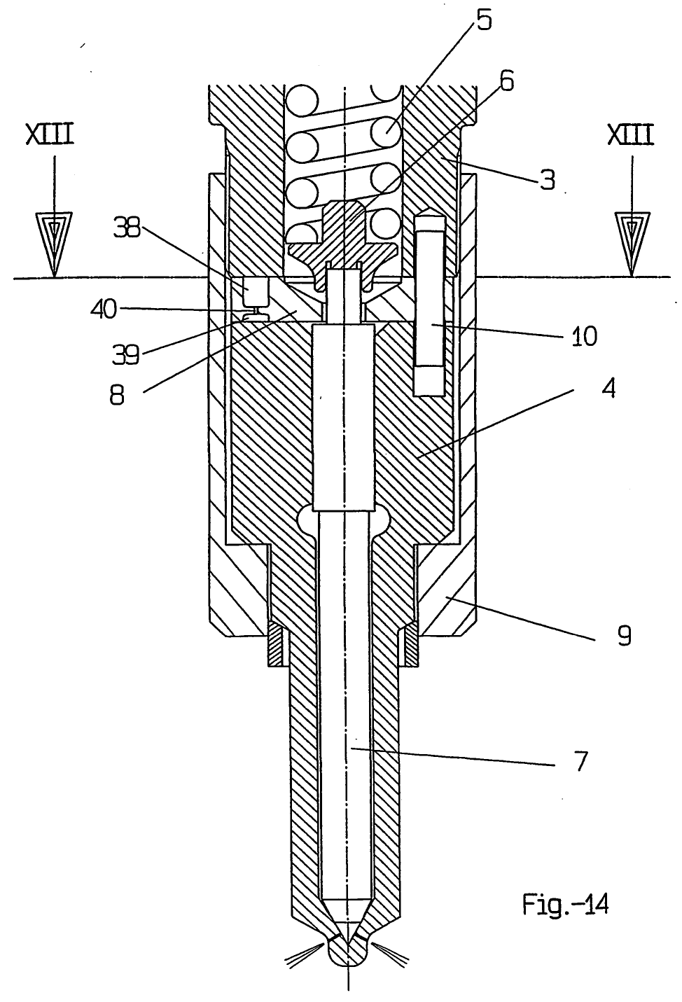

FIG. 14 shows a portion of FIG. 11 on a larger scale

FIGS. 1 to 8 show different sections through an injection nozzle 1, whose nozzle holder 2 comprises a holding body 3 and a nozzle body 4. In holding body 3 there is housed a compression spring 5, which is preloaded via a thrust pin 6 against a nozzle needle 7. Between holding body 3 and nozzle body 4 there is disposed an intermediate plate, which is designed as a disk-shaped filter body 8. Holding body 3 and nozzle body 4 are clamped together by means of a nozzle-clamping nut 9 and are centered relative to one another by means of two fixing pins 10. To the holding body 3 there is connected a fuel feed 11 via a port connection 12 on pressure line 13, whose upper portion 14, via filter body 8 and a lower portion 15, is in communication with an annular space 16 for actuation of nozzle needle 7. At the upper end of the low-pressure space containing compression spring 5, there is provided a bleed port 17. Where the said components appear in FIGS. 1 to 8, they are denoted by like reference numerals. The sections according to FIGS. 3 and 4 show the same cross section; they differ merely by different particulars of the section lines of the associated axial sections according to FIGS. 1 and 2.

Section line I-I according to FIG. 3 relates to the illustration according to FIG. 1; section line II-II according to FIG. 4 relates to the illustration according to FIG. 2. Whereas the section plane on the right side of the section illustration according to FIGS. 1 and 2 passes through a fixing pin 10 in each case, the sections on the left side differ from one another as regards their longitudinal axes; in FIG. 1, the corresponding section plane runs through fuel pressure line 13; in FIG. 2, the corresponding section plane runs through a slit 35 in filter body 8.

In the practical example according to FIGS. 1 to 8, with enlarged representation of an axial portion illustrated on larger scale in FIG. 9, filter body 8 is composed of three disks, as is evident from the section diagrams according to FIGS. 4 to 6. In contrast, in the second embodiment according to FIGS. 10 to 13, with a portion illustrated on larger scale in FIG. 14, filter body 8 is of one-piece construction. As regards their remaining structure, the two embodiments are identical, and so the following description of the two embodiments can be limited to the different configurations of filter body 8.

According to the first embodiment (FIGS. 1 to 8), filter body 8 is composed of three disks, namely an upper cover disk 30, a filter disk 31 and a lower cover disk 32. Through these there passes a flow from pressure line 13 from top to bottom. Compared with filter disk 31, which is formed as a thin lamella, the two cover disks 30, 32 are made of thicker plates, both of circular shape, as is evident in FIGS. 4 to 6. FIG. 4 shows upper cover plate 30 with an opening 33 that has approximately the shape of a semicircular arc and at 12 o'clock position is provided with an outward bulge 34. Moreover, upper cover disk 30 is provided with two boreholes for the two fixing pins 10. In the section diagram according to FIG. 4, there is also evident, in filter disk 31 disposed thereunder (see FIG. 5), the laser cut 35 made therein and provided in the region of projection 34 with an inwardly directed deflection 36. Deflection 36 of laser cut 35 and opposite bulge 34 of opening 35 are necessary, because pressure line 13 opens between the two, as is evident in FIG. 1. In this way it is ensured that pressure line 13 does not open directly opposite laser cut 35, and in turn that entrained residues cannot lead to clogging, but instead are distributed sideways in the region of laser cut 35, from where they can pass through laser cut 35 under the right conditions and thus through filter body 8.

Lower cover disk 32, which is disposed on the underside of filter disk 31 and which is illustrated in FIG. 6, has an opening 37, which is formed approximately in the same shape as opening 33 in upper cover disk 30. By means of openings 33 in upper cover disk 30 and of opening 37 in lower cover disk 32, there are created, relative to filter disk 31 disposed therebetween and provided with laser cut 35, prechambers that ensure distribution of the fuel over the entire length of laser cut 35. In this connection it is to be noted that its effective total length, multiplied by the width of the laser cut, corresponds to the respectively desired filter surface, while at the same time achieving a continuous filter slot, whose cut width determines the quality of the filtering effect.

FIGS. 7 and 8 respectively show a view of the end sides of the components adjoining filter body 8. Specifically, FIG. 7 shows nozzle body 4 and FIG. 8 shows holding body 3. Both sections show the two fixing pins 10 as well as the mouth of pressure line 13, namely the lower portion 15 thereof in FIG. 7 and the upper portion 14 thereof in FIG. 8.

FIG. 9 shows the first embodiment with the layout of axial sections according to I-I of FIG. 3 on a larger scale, together with the same reference numerals as in the foregoing.

In the second embodiment according to FIGS. 10 to 13, filter body 8 is of one-piece construction. The identical section diagrams 12 and 13 show filter body 8 in overhead view. It contains a groove 38 in its upper side and a similarly shaped but much shallower groove 39 in its underside, the two grooves being disposed exactly one above the other. The common groove bottom is formed by a thin intermediate strip, in which there are made two laser cuts 40, which together form the filter surface. In FIG. 14, which illustrates a portion of FIG. 11 on a larger scale, filter body 8 is clearly recognizable, together with upper groove 38 and lower groove 39. Corresponding to the chosen layout of sections according to XI-XI in FIG. 13, there can be clearly seen laser cut 40, which places the two grooves 38, 39 in communication with one another in the region of the intermediate strip. Only residues passing through this laser cut 40 from upper groove 38 into lower groove 39 travel through lower portion 15 of the pressure line (see FIG. 10) to nozzle needle 7, or in other words are fed with the fuel to combustion.

1. An injection nozzle (1) with fuel filter for reciprocating-piston internal-combustion engines, with a substantially disk-shaped filter body (8) in the pressure line (13) of a nozzle holder (2) comprising holding body (3) and nozzle body (4),
characterized in that
the filter body (8) is clamped between holding body (3) and nozzle body (4),
in that the filter surface or filter slots are formed by one or more fine cuts in the filter body (8) and
in that the pressure line (13) opens and/or discharges into prechambers of the filter body (8), which prechambers are in communication with the filter surface or the filter slots.

2. An injection nozzle according to claim 1,
characterized in that
the fine cuts are formed by laser cuts (35).

3. An injection nozzle according to claim 1,
characterized in that
the prechambers are formed by grooves (38, 39), which substantially contain the fine cuts.

4. An injection nozzle according to claim 1,
characterized in that
the filter body (8) is composed of a plurality of filter disks (30, 31, 32).

5. An injection nozzle according to claim 4,
characterized in that
one or more prechambers is or are designed as openings (33, 37) of separate filter disks (30, 32), which are composed of at least one filter disk (31) containing the filter surface or filter slots.
